(19) United States
(12) Patent Application Publication
(10) Pub. No.: US 2025/0225013 A1
(43) Pub. Date: Jul. 10, 2025

(54) COMPUTING SYSTEM AND TIMEOUT DETECTION METHOD

(71) Applicant: SK hynix Inc., Icheon-si (KR)

(72) Inventor: Kyu Ho CHOI, Icheon-si (KR)

(21) Appl. No.: 18/928,014

(22) Filed: Oct. 26, 2024

(30) Foreign Application Priority Data
Jan. 4, 2024 (KR) 10-2024-0001376

(51) Int. Cl. G06F 11/07; G06F 11/14; G06F 11/34

(52) U.S. Cl. CPC G06F 11/0757; G06F 11/1441; G06F 11/3466

(57) ABSTRACT

A storage device may include: a memory device for performing operations in response to a command received from an external host device; and a memory controller for measuring a performance time of the operations corresponding to the command, and generating a timeout signal in response to occurrence of a timeout. The memory controller may receive a request including timeout information for the command from the external host device, detect whether performance of the operations has been completed before a timeout reference time elapses based on the timeout information, and transmit, as a response to the command, the timeout signal generated corresponding to the timeout, in which the performance of the operations is not completed until before the timeout reference time elapses.

### CROSS-REFERENCE TO RELATED APPLICATION

The present application claims priority under 35 U.S.C. § 119 (a) to Korean patent application number 10-2024-0001376 filed on Jan. 4, 2024, in the Korean Intellectual Property Office, the entire disclosure of which is incorporated by reference herein.

### BACKGROUND

### 1. Technical Field

The present disclosure generally relates to a computing system, and more particularly, to a computing system and a recovery method in timeout detection.

### 2. Related Art

A computing system is a device that stores data under the control of a host device such as a computer or a smartphone. A storage device may perform operations according to a command received from a host. The storage device may include a memory device for storing data and a memory controller for controlling the memory device. Memory devices are classified into volatile memory devices and nonvolatile memory devices.

In a state in which a current and a voltage of the computing system are unstable, a bit or byte crush may occur in data stored in a volatile memory device. A stuck phenomenon may occur in the computing system due to the bit or byte crush. When the stuck phenomenon occurs, a physical recovery operation may be performed on the computing system.

### SUMMARY

Embodiments provide a computing system and a method of detecting a timeout of a command, in which a timeout error of the command is detected, and a reset operation for fast recover is performed when the timeout error is detected.

In accordance with an aspect of the present disclosure, there is provided a storage device including: a memory device configured to perform operations in response to a command received from an external host device; and a memory controller configured to measure a performance time of the operations, and to generate a timeout signal in response to an occurrence of a timeout with respect to the operations, wherein the memory controller receives a request including a timeout information for the command received from the external host device, detects whether performance of the operations has been completed before a timeout occurs based on the timeout information, and transmits, in response to the command, the timeout signal generated when the performance of the operations is not completed until before the timeout.

In accordance with another aspect of the present disclosure, there is provided a computing system including: a host device configured to generate a command instructing operations to be performed in a memory device; and a storage device including a memory device configured to perform the operations and a memory controller configured to control the memory device, wherein the host device includes a timeout information for the command, and transmits, to the storage device, a first request instructing performance of a timeout detection operation on the command, and wherein, in response to the first request, the memory controller detects whether performance of the operations have been completed before a timeout reference time included in the timeout information elapses, and transmits, to the host device, a timeout signal for a timeout in which the performance of the operations is not completed before the timeout reference time elapses.

In accordance with still another aspect of the present disclosure, there is provided a method of operating a storage device, the method including: receiving requests from a host device including a timeout information for a command; receiving from the host device the command, which instructs operations to be performed in a memory device; detecting a timeout error when the operations corresponding to the command are not completed before a timeout reference time included in the timeout information elapses; and performing a reset operation corresponding to the timeout error.

### BRIEF DESCRIPTION OF THE DRAWINGS

Example embodiments will now be described more fully hereinafter with reference to the accompanying drawings; however, the inventions may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a computing system in accordance with an embodiment of the present disclosure.

FIG. 2 is a diagram illustrating a computing system in accordance with an embodiment of the present disclosure in accordance with an embodiment of the present disclosure.

FIG. 3 is a diagram illustrating transmission of a command and device reset in the computing system in accordance with an embodiment of the present disclosure.

FIG. 4 is a diagram illustrating detection of a timeout error of a command and reset of a computing system in accordance with an embodiment of the present disclosure.

FIG. 5 is a flowchart illustrating a method of detecting a timeout error of a command and resetting a computing system in accordance with an embodiment of the present disclosure.

### DETAILED DESCRIPTION

The specific structural or functional descriptions disclosed herein are merely illustrative for the purpose of describing embodiments according to the concept of the present disclosure. The embodiments according to the concept of the present disclosure can be implemented in various forms, and cannot be construed as limited to the embodiments set forth herein.

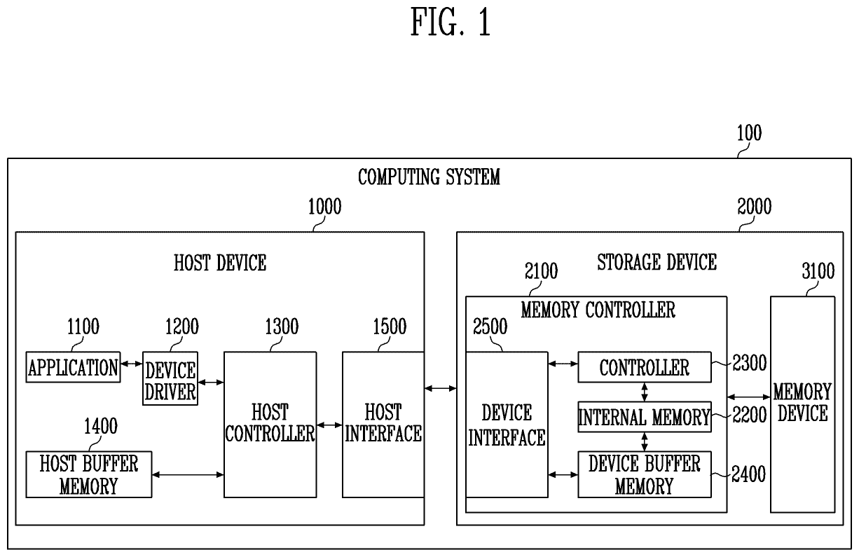

FIG. 1 is a diagram illustrating a computing system in accordance with an embodiment of the present disclosure.

Referring to FIG. 1, a computing system 100 may include a host device 1000 and a storage device 2000.

The host device 1000 may perform various operations required when the computing system 100 operates. For example, the host device 1000 may drive an operating system used in the computing system 100, and may execute various application programs in the operating system. The host device 1000 may write data to the storage device 2000 or read data written to the storage device 2000.

The host device 1000 may include an application 1100, a device driver 1200, a host controller 1300, a host buffer memory 1400, and a host interface 1500.

The application 1100 may be an operating system or an application program, which is executed in the host device 1000, or may be firmware or software, which manages an application program executed in the host device 1000. The application 1100 may transmit, to the device driver 1200, an input/output request for data transmission to the storage device 2000 or for data reception from the storage device 2000. The input/output request may mean at least one of a read request, a write request, or an erase request, but the present disclosure is not limited thereto.

The device driver 1200 may convert an input/output request generated by the application 1100 into requests specified in a protocol specification, and transmit the converted requests to the host controller 1300. The device driver 1200 may be implemented through firmware or software.

The host controller 1300 may control overall operations inside the host device 1000. For example, when a write request is received from the device driver 1200, the host controller 1300 may provide data stored in the host buffer memory 1400 to the storage device 2000 through the host interface 1500. For example, when a read request is received from the device driver 1200, the host controller 1300 may receive data from the storage device 2000 through the host interface 1500.

The host buffer memory 1400 may be used as a main memory or a cache memory of the host device 1000. The host buffer memory 1400 may temporarily store data to be provided to the storage device 2000. The host buffer memory 1400 may be used as a driving memory for driving the application 1100 or the device driver 1200.

The host interface 1500 may be connected to a device interface 2500 of the storage device 2000 through lines used to transmit or receive data. The lines connecting the host interface 1500 and the device interface 2500 to each other may be a data line, a reset line transmitting a hardware reset signal, a clock line transmitting a reference clock signal, and the like. The data line may be configured with a plurality of pairs, and a pair of one data input line and one data output line may be referred to as a lane. The host interface 1500 may communicate with the device interface 2500, using at least one interface protocol among a Peripheral Component Interconnect-Express (PCI-E), an Advanced Technology Attachment (ATA), Serial ATA (SATA), Parallel ATA (PATA), Universal Serial Bus (USB), Multi-Media Card (MMC), Enhanced Small Disk Interface (ESDI), Integrated Drive Electronics (IDE), Mobile Industry Processor Interface (MIPI), Universal Flash Storage (UFS), Small Computer System Interface (SCS), and Serial Attached SCSI (SAS), but embodiments of the present disclosure are not limited thereto.

The storage device 2000 may write data under the control of the host device 1000 or provide written data to the host device 1000. The storage device 2000 may be implemented as a Solid State Driver (SSD), a Multi-Media Card (MMC), an embedded MMC (eMMC), a Secure Digital (SD) card, or a Universal Flash Storage (UFS), but embodiments of the present disclosure are not limited thereto.

The storage device 2000 may include a memory controller 2100 and a memory device 3100. The memory device 3100 may include a nonvolatile memory. The memory device 3100 may perform a write, read or erase operation under the control of the memory controller 2100.

The memory controller 2100 may control overall operations of the storage device 2000. The memory controller 2100 may include an internal memory 2200, a controller 2300, a device buffer memory 2400, and the device interface 2500.

The internal memory 2200 may store various information that the memory controller 2100 or the controller 2300 generates while operating.

The controller 2300 may control a write, read or erase operation on the memory device 3100. The controller 2300 may exchange data with the memory device 3100 or the device buffer memory 2400 through an address bus or a data bus.

The device buffer memory 2400 may temporarily store data to be stored in the memory device 3100 or data read from the memory device 3100. The device buffer memory 2400 may be implemented as a volatile memory or a nonvolatile memory.

The device interface 2500 may communicate with the host interface 1500, using at least one interface protocol among a Peripheral Component Interconnect-Express (PCI-E), an Advanced Technology Attachment (ATA), Serial ATA (SATA), Parallel ATA (PATA), Universal Serial Bus (USB), Multi-Media Card (MMC), Enhanced Small Disk Interface (ESDI), Integrated Drive Electronics (IDE), Mobile Industry Processor Interface (MIPI), Universal Flash Storage (UFS), Small Computer System Interface (SCS), and Serial Attached SCSI (SAS), but embodiments of the present disclosure are not limited thereto.

In an embodiment of the present disclosure, the computing system may be a memory system having a multi-layer structure. A computing system having a multi-layer structure is already been disclosed in the art. Therefore, in this specification, descriptions of detailed contents may be omitted. Hereinafter, for convenience of description, the computing system may be assumed to be a UFS system. Each layer of the UFS system may be implemented with hardware, firmware or software.

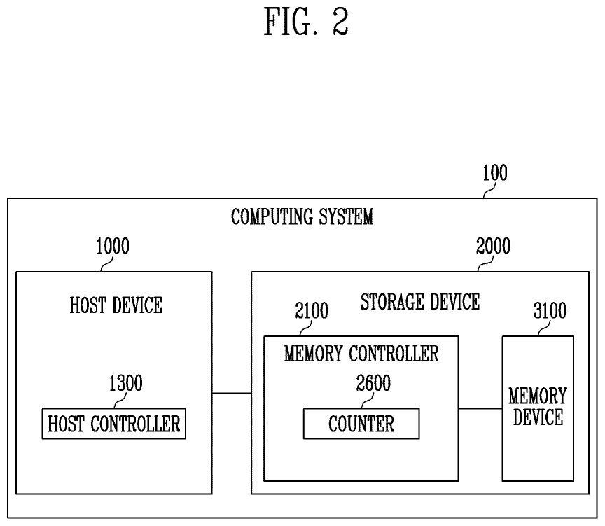

FIG. 2 is a diagram illustrating a computing system in accordance with an embodiment of the present disclosure.

Referring to FIG. 2, a computing system 100 may include a host device 1000 and a storage device 2000. Although not shown in FIG. 2, the computing system 100 shown in FIG. 2 may include the components described above and shown in FIG. 1.

The host device 1000 may include a host controller 1300 that controls overall operations of the host device 1000. The host device 1000 may generate a command instructing operations to be performed in a memory device 3100, and transmit the generated command to the storage device 2000. In an embodiment of the present disclosure, the computing system 100 may be assumed to be a UFS system, and therefore, the generated command may be an SCSI command. The SCSI command may include command content information and length information.

The storage device 2000 may include the memory device 3100 that performs operations in response to the command received from the host device 1000 and a memory controller 2100, which controls overall operations of the storage device 2000. The storage device 2000 may be a UFS, and therefore, the memory device 3100 may be a nonvolatile memory.

The memory controller 2100 may detect an error occurring in operations performed by the memory device 3100, and generate an error signal in response to the occurrence of the error. A timeout in which operations corresponding to a command are not completed within a specific period of time may be included in the detected error. The memory controller 2100 may transmit the generated error signal to the host device 1000. The memory controller 2100 may reset the storage device 2000 in response to the detection of the error.

The host device 1000 may generate requests for a command, and transmit the generated requests to the memory controller 2100. In an embodiment of the present disclosure, the requests for the command may include command timeout information. The timeout information may include at least one of first information indicating a timeout reference time, and a second information indicating whether an additional operation is to be performed corresponding to a timeout, in which operations of the memory device 3100 are not completed within the timeout reference time. In an embodiment of the present disclosure, when operations corresponding to a command are not completed during a set period, processing associated with the operations may determine that the corresponding command is no longer valid, and that the corresponding command may be expired.

The memory controller 2100 may set a timeout reference time for a command based on the first information. The memory controller 2100 may determine whether a reset operation on the storage device 2000 is to be performed, when the second information indicates performance of an additional operation. The memory controller 2100 may determine whether a cause of the timeout is a delay in processing the command. The memory controller 2100 may trigger the reset operation on the storage device 2000, when the controller determines that the cause of the timeout is not delay inprocessing of the command.

The memory controller 2100 may measure a performance time for operations corresponding to the received command. The memory controller 2100 may detect an occurrence of a timeout of the command when the operations are not completed when the timeout reference time elapses. The memory controller 2100 may transmit, to the host device 1000, a timeout signal indicating the occurrence of the timeout.

In another embodiment of the present disclosure, the host device 1000 may generate a first request for a command. The first request may a request for whether an operation of detecting a timeout of the command is to be performed. The host device 1000 may generate a second request for a command. The second request may be a request for a timeout reference time. The host device 1000 may generate the second request indicating a timeout reference time corresponding to a characteristic of an application included in the computing system. The host device 1000 may generate a third request for a command. The third request may be a request for whether an additional operation corresponding to the timeout of the command is to be performed. The memory controller 2100 may perform a reset operation on the storage device 2000 based on the third request, which indicates whether the additional operation is to be performed.

The memory controller 2100 may set a timeout reference time, based on the second request. The memory controller 2100 may detect a timeout of the command, in which operations of the command are not completed within the timeout reference time, based on the first request. The memory controller 2100 may transmit, to the host device 1000, a timeout signal for triggering a reset operation of the host device 1000, corresponding to detection of the timeout of the command.

The memory controller 2100 may include a counter 2600, which measures a performance time of operations performed by the memory device 3100. In an embodiment of the present disclosure, the counter 2600 may be a real time clock. When a performance time of operations, which is measured by the real time clock, reaches the timeout reference time, the memory controller 2100 may determine that a timeout has occurred.

The memory controller 2100 may suspend performance of operations corresponding to the command in response to the detection of the timeout. The memory controller 2100 may delete a command related to the timeout from the storage device 2000. The memory controller 2100 may perform a reset operation on the storage device 2000 in response to the occurrence of the timeout.

The memory controller 2100 may generate a timeout signal for triggering a reset of the host device 1000, corresponding to the performance of the reset operation on the storage device 2000. The memory controller 2100 may transmit the generated timeout signal as an interrupt signal to the host device 1000.

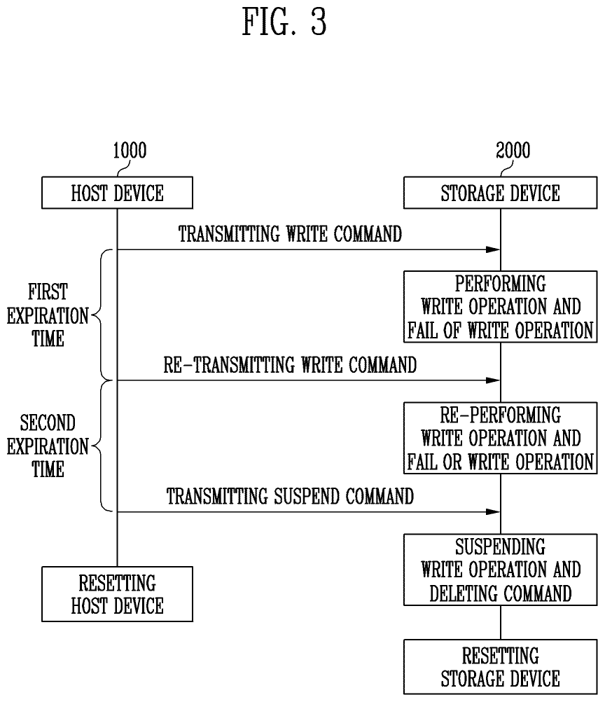

FIG. 3 is a diagram illustrating transmission of a command and device reset in the computing system in accordance with an embodiment of the present disclosure.

FIG. 3 illustrates a process in which a host device 1000 and a storage device 2000 are reset when a command transmitted by a host device 1000 is expired. For convenience of description, it is assumed that the host device 1000 transmits a write command to the storage device 2000.

The host device 1000 may transmit a write command to the storage device 2000. The storage device 2000 may perform a write operation corresponding to the received write command. When a stuck phenomenon occurs in the computing system, the write operation may fail. The storage device 2000 may not transmit any response with respect to the write command. When an operation corresponding to the received command is completed, the storage device 2000 may transmit, to the host device 1000, a signal indicating that the operation has been completed (not illustrated).

When the host device 1000 does not receive any operation completion signal from the storage device 2000 during a predetermined first expiration time, the host device 1000 may re-transmit the write command. The storage device 2000 may re-perform the write operation, but the write operation may fail again due to the stuck phenomenon still occurring in the computing system. When the write operation fails again, the storage device 2000 may not transmit any response to the host device 1000.

The host device 1000 may transmit a suspend command to the storage device 2000 when the host device 1000 does not receive any operation completion signal from the storage device 2000 during a predetermined second expiration time. The host device 1000 may reset the host device 1000 after the suspend command is transmitted. The storage device 2000 may suspend the write operation being performed, corresponding the received suspend command, and delete all received write commands. The storage device 2000 may perform a reset operation for recovery. The host device 1000 and the storage device 2000 are reset, so that the stuck phenomenon occurring in the computing system can be resolved.

Each of the first expiration time and the second expiration time may be a predetermined amount time. The first expiration time and the second expiration time may be the same. For example, it may be assumed that each of the first expiration time and the second expiration time is 30 seconds.

In FIG. 3, the host device 1000 may determine whether the stuck phenomenon has occurred in the computing system. The storage device 2000 merely performs the operation corresponding to the received command, and may not monitor any timeout of the command. The computing system performs the reset operation for recovery only when both the first expiration time and the second expiration time are exceeded, and therefore, reliability and stability may decrease.

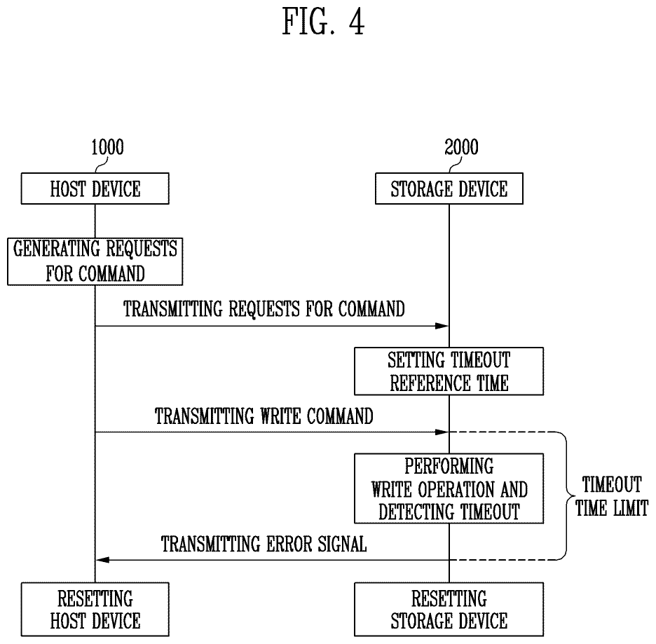

FIG. 4 is a diagram illustrating detection of a timeout error of a command and reset of a computing system in accordance with an embodiment of the present disclosure.

Referring to FIG. 4, a host device 1000 may transmit a request for expiration of a command to a storage device 2000, and the storage device 2000 may detect a timeout of the command. The storage device 2000 may transmit, to the host device 1000, a timeout signal for inducing reset of the computing system, corresponding to occurrence of the timeout. As in FIG. 3, it may be assumed that the host device 1000 transmits a write command to the storage device 2000.

More specifically, the host device 1000 may generate requests for a command. For example, requests associated with expiration of the command may include a first request indicating whether an operation of detecting a timeout error of the command is to be performed, a second request indicating a timeout reference time, and a third request indicating whether an additional operation of determining whether a reset operation on the storage device 2000 is to be performed. The host device 1000 may simultaneously or sequentially transmit the first request, the second request, and the third request to the storage device 2000. Descriptions of the requests for command may correspond to the descriptions above with reference to FIG. 2.

The storage device 2000 may set a timeout reference time, based on the second request. In an embodiment of the present disclosure, the timeout reference time may be set shorter than the first expiration time or the second expiration time, which is shown in FIG. 3. The storage device 2000 may detect whether a timeout of the received command has occurred based on the first request, or determine whether the reset operation on the storage device 2000 is to be performed, based on the third request. The storage device 2000 may transmit, to the host device 1000, a timeout signal for triggering a reset operation on the host device 1000, which corresponds to the reset operation on the storage device 2000.

The host device 1000 may transmit a write command to the storage device 2000. The host device 1000 may simultaneously or sequentially transmit the request for the command and the write command.

The storage device 2000 may perform a write operation corresponding to the received write command. The storage device 2000 may detect whether the write operation has been completed within the timeout reference time. The storage device 2000 may detect a timeout of the write command when the performance of the write operation has not been completed before the timeout reference time is reached.

The storage device 2000 may suspend the write operation in response to the detection of the timeout of the write command, and delete the write command from the storage device 2000. The reset operation on the storage device 2000 may include an operation of suspending the write operation and deleting the write command. The storage device 2000 may transmit, to the host device 1000, a timeout signal for triggering reset of the host device 1000, corresponding to the performance of the reset operation on the storage device 2000.

In an embodiment of the present disclosure, the memory controller included in the storage device 2000 may monitor the timeout of the command received from the host device 1000, and transmit a monitoring result to the host device 1000. Since the memory controller sets the timeout reference time to be shorter than the first expiration time and the second expiration time of the host device 1000, a time required for reset of the computing system in the case shown in FIG. 4 is shorter as compared with the case shown in FIG. 3. For example, if each of the first expiration time and the second expiration time is 30 seconds long, and a timeout reference time for the second request may be set to 10 seconds. Thus, while 60 or more seconds is required to perform a reset operation for resolving a stuck phenomenon occurring in the computing system of FIG. 3, only about 10 seconds is required for reset of the computing system in FIG. 4 after a command is transmitted. In accordance with embodiments of the present disclosure, timeouts can be more rapidly detected, and reset operations of the computing system can be more rapidly performed.

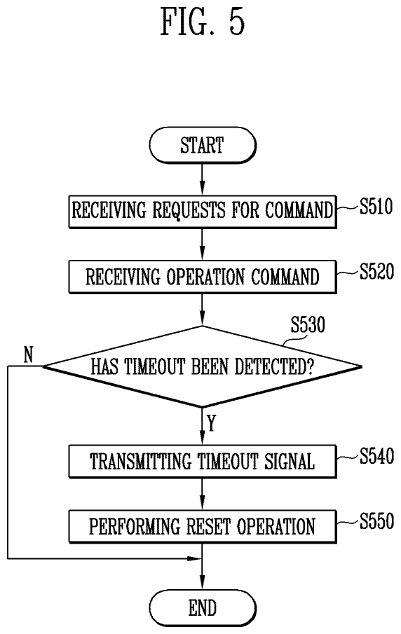

FIG. 5 is a flowchart illustrating a method of detecting a timeout error of a command and resetting a computing system in accordance with an embodiment of the present disclosure.

Referring to FIG. 5, a memory controller may monitor whether a timeout of a command received from a host device has occurred. The memory controller may set a timeout reference time that is shorter than a command expiration time set in the host device, and detect a timeout of a command, in which performance of operations corresponding to the command is not completed within the timeout reference time. The memory controller may reset the computing system, corresponding to the detection of the timeout, to rapidly recover the computing system when compared with a reset of the computing system by the host device.

In step S510, a memory controller may receive requests for a command from a host device. The memory controller may receive a first request indicating whether an operation of detecting a timeout of the command is to be performed, a second request indicating a timeout reference time, and a third request indicating whether an additional operation corresponding to the timeout of the command is to be performed.

In step S520, the memory controller may receive, from the host device, a command instructing operations to be performed in the memory device. In an embodiment of the present disclosure, the received command may be an SCSI command. When the first request instructs that an operation of detecting a timeout error of the command is not to be performed, the computing system may be reset in accordance with steps described in FIG. 3.

In step S530, the memory controller may detect a timeout in which the operations corresponding to the command are not completed within the timeout reference time, based on timeout information included in the requests for the command. The memory controller may measure a performance time of the operations, corresponding to a first request that instructs performance of the operation of detecting the timeout error of the command. The memory controller may set the timeout reference time based on the second request. The memory controller may detect whether the performance of the operations has been completed before the timeout reference time elapses.

The memory controller may determine whether a reset operation on the storage device is to be performed, corresponding to a third request that instructs performance of an additional operation. The memory controller may trigger the reset operation, when a cause of the timeout is not a delay of the command. The memory controller may not perform the reset operation of the computing system, corresponding to the performance and completion of the operations within the timeout reference time.

In step S540, the memory controller may transmit, to the host device, a timeout signal for triggering a reset operation on the host device, corresponding to the detection of the timeout of the command. The host device receiving the timeout signal may perform the reset operation on the host device. In step S550, the memory controller may perform the reset operation on the storage device. The memory controller may suspend the performance of the operations corresponding to the command, corresponding to the transmission of the timeout signal, and delete the received command from the storage device.

In an embodiment of the present disclosure, the steps S540 and S550 may be simultaneously performed, or the step S550 may be performed before the step S540. When the step S550 is performed earlier than the step S540 or when the step S550 is performed simultaneously with the step S540, the timeout signal may be transmitted to the host device, corresponding to the performance of the reset operation on the storage device.

Descriptions of the respective steps shown in FIG. 5 may correspond to the descriptions shown in FIGS. 2 and 4.

In accordance with the present disclosure, there can be provided a computing system and a timeout detecting method thereof, in which a reset operation is induced by rapidly detecting a timeout error of a command, so that a faster recovery operation can be performed.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A storage device comprising:
a memory device configured to perform operations in response to a command received from a host device; and
a memory controller configured to measure a performance time of the operations and to generate a timeout signal in response to an occurrence of a timeout with respect to the operations,
wherein the memory controller:
receives a request including a timeout information for the command received from the host device;
detects whether performance of the operations has been completed before the timeout occurs based on the timeout information; and
transmits, in response to the command, the timeout signal generated when the performance of the operations is not completed until before the timeout.

2. The storage device of claim 1, wherein the timeout information includes a first information indicating a timeout reference time, and
wherein the memory controller sets the timeout reference time, corresponding to the command, based on the first information.

3. The storage device of claim 1, wherein the timeout information includes a second information indicating whether an additional operation corresponding to the timeout is to be performed, and
wherein the memory controller determines whether a reset operation on the storage device is to be performed when the second information indicates performance of the additional operation.

4. The storage device of claim 1, wherein the memory controller further includes a counter that measures the performance time of the operations using a real time clock included in the storage device.

5. The storage device of claim 3, wherein the memory controller performs the reset operation including suspension of the performance of the operations corresponding to the command and deletion of the command when the timeout occurs.

6. The storage device of claim 5, wherein the memory controller generates the timeout signal for triggering reset of the host device.

7. The storage device of claim 6, wherein the timeout signal is an interrupt signal.

8. A computing system comprising:
a host device configured to generate a command instructing operations to be performed in a memory device; and
a storage device including the memory device configured to perform the operations and a memory controller configured to control the memory device,
wherein the host device includes a timeout information for the command, and transmits, to the storage device, a first request instructing performance of a timeout detection operation on the command, and
wherein, in response to the first request, the memory controller detects whether performance of the operations has been completed before a timeout reference time included in the timeout information elapses, and transmits, to the host device, a timeout signal for a timeout in which the performance of the operations is not completed before the timeout reference time elapses.

9. The computing system of claim 8, wherein the host device transmits, to the storage device, a second request instructing setting of the timeout reference time, and
wherein the memory controller sets the timeout reference time in response to the command.

10. The computing system of claim 9, wherein the memory controller includes a real time clock that measures a performance time of the operations.

11. The computing system of claim 8, wherein the host device transmits, to the storage device, a third request instructing performance of an additional operation of determining whether a reset operation on the storage device is to be performed when the timeout occurs, and
wherein the memory controller detects the timeout, performs the reset operation on the storage device, and transmits, to the host device, the timeout signal for triggering a reset operation on the host device.

12. The computing system of claim 11, wherein the reset operation on the storage device includes an operation of suspending the performance of the operations corresponding to the command and deleting the command.

13. The computing system of claim 11, wherein the host device performs the reset operation on the host device in response to the timeout signal.

14. A method of operating a storage device, the method comprising:
receiving requests from a host device including a timeout information for a command;
receiving from the host device the command, which instructs operations to be performed in a memory device;
detecting a timeout error when the operations corresponding to the command are not completed before a timeout reference time included in the timeout information elapses; and
performing a reset operation corresponding to the timeout error.

15. The method of claim 14, wherein the receiving of the requests includes:
receiving a first request instructing determining whether an operation of detecting the timeout error of the command is to be performed;
receiving a second request instructing setting of the timeout reference time; and
receiving a third request instructing determining whether an additional operation of determining whether a reset operation on the storage device is to be performed.

16. The method of claim 15, wherein the detecting of the timeout error includes:
setting the timeout reference time, based on the second request; and
determining whether the performance of the operations has been completed before the timeout reference time elapses, based on the first request.

17. The method of claim 16, wherein the performing of the reset operation includes performing the reset operation on the storage device based on the third request when the timeout error occurs, and
wherein the reset operation on the storage device includes suspension of the performance of the operations corresponding to the command and deletion of the command.

18. The method of claim 17, wherein the performing of the reset operation further includes transmitting, to the host device, a timeout signal for triggering a reset operation on the host device.
